(19) United States
(12) Patent Application Publication
(10) Pub. No.: US 2013/0163174 A1
(43) Pub. Date: Jun. 27, 2013

(54) HEAT DISSIPATION APPARATUS FOR MEMORY CARDS

(71) Applicants: WEI-MIN HE, Shenzhen City (CN); JUN-HUI WANG, Shenzhen City (CN)

(72) Inventors: WEI-MIN HE, Shenzhen City (CN); JUN-HUI WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/340,718

(22) Filed: Dec. 30, 2011

(30) Foreign Application Priority Data
Dec. 22, 2011 (CN) 201110435086.7

(51) Int. Cl. G06F 1/20; F28F 9/00

(52) U.S. Cl. 361/679.32; 165/67

(57) ABSTRACT

A heat dissipation apparatus is used for accelerating heat dissipation of a memory card mounted to a circuit board. The heat dissipation apparatus includes a mounting bracket supported on the circuit board and a fan mounted to the mounting bracket. The mounting bracket includes to a mounting plate arranged over the memory card, and a plurality of legs extending down from the mounting plate to be fixed to the circuit board. The fan is attached to the mounting plate to align with the memory card.

### BACKGROUND

1. Technical Field

The present disclosure relates to an apparatus for dissipating heat generated by memory cards.

2. Description of Related Art

Memory cards in an electronic device are heat generating components. If the heat generated by the memory cards cannot be dissipated in time, the temperature of the memory cards will rise to deteriorate the work efficiency or even damage the memory cards.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a heat dissipation apparatus, together with a circuit board and a plurality of memory cards mounted to the circuit board.

FIG. 2 is an enlarged view of the encircled portion II of FIG. 1.

FIG. 3 is an assembled view of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

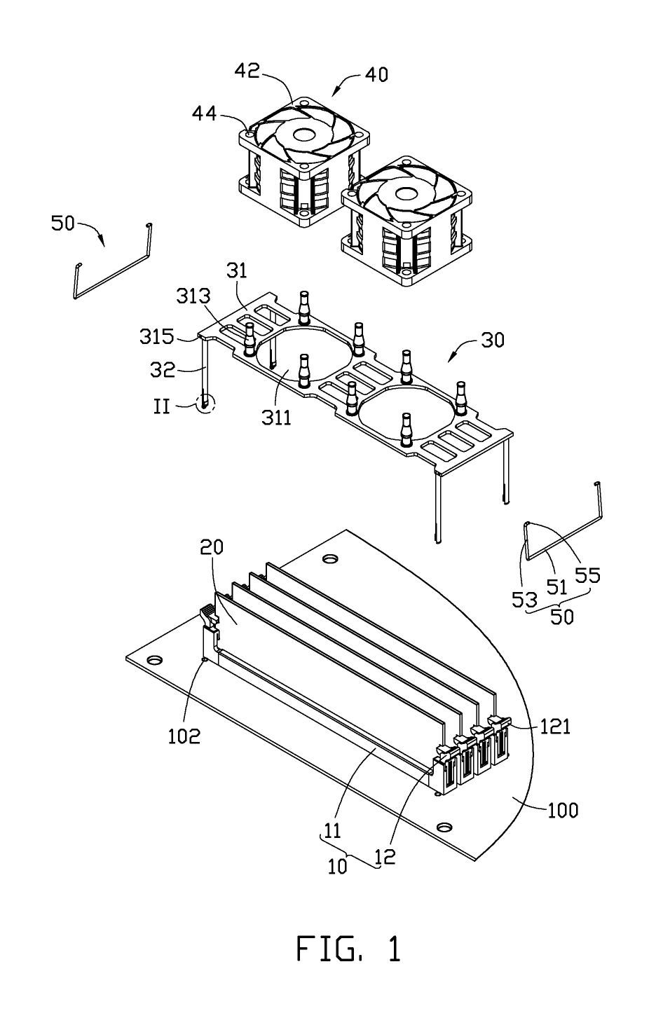

FIG. 1, shows an exemplary embodiment of a heat dissipation apparatus for a plurality of memory cards 20 including a mounting bracket 30, two fans 40, and two handles 50.

The memory cards 20 are coupled to a plurality of memory connectors 10 disposed on a circuit board 100. Each of the memory connectors 10 includes a coupling slot 11 electrically connecting a corresponding memory card 20, and two retaining portions 12 rotatably mounted to opposite ends of the coupling slot 11 to be retained at opposite ends of the corresponding memory card 20. Each of the retaining portions 12 includes a grip 121 protruding away from the corresponding memory card 20 to facilitate manipulation of the retaining portion 12. The circuit board 100 defines four locating holes 102 adjacent to and around the memory cards 20.

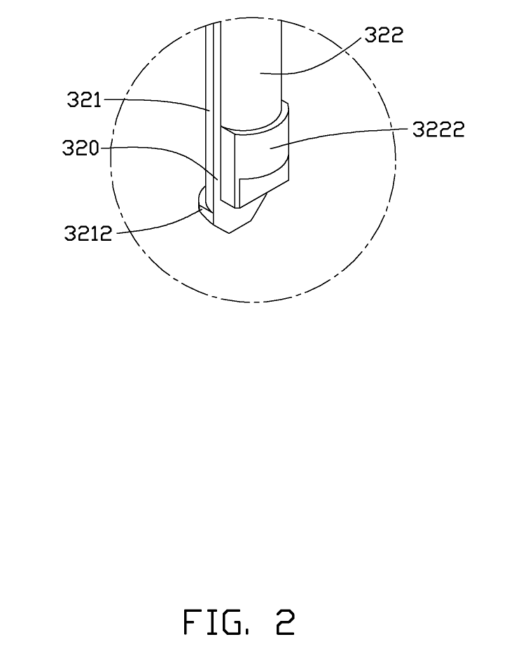

Referring to FIGS. 1 and 2, the mounting bracket 30 includes a substantially rectangular mounting plate 31 and four legs 32 perpendicularly extending down from four corners of the mounting plate 31. The mounting plate 31 defines two through holes 311. Four fasteners 313, which are made of rubber, extend up from the mounting plate 31, around each through hole 311. Each of opposite lateral side surfaces of the mounting plate 31 defines two pivot holes 315, respectively adjacent to opposite ends of the mounting plate 31. An axial split 320 is defined in a bottom end of each of the legs 32 opposite to the mounting plate 31, to form a first retaining portion 321, and a second retaining portion 322 shorter than the first retaining portion 321, at opposite sides of the split 320. The first and second retaining portions 321 and 322 are resilient. A catch 3212 protrudes from a distal end of the first retaining portion 321, opposite to the second retaining portion 321. A block 3222 protrudes from a distal end of the second retaining portion 322, opposite to the first retaining portion 322, and is located over the catch 3212.

Each fan 40 includes two spaced end boards 42, each defining four mounting holes 44.

In one embodiment, each handle 50 is a metal wire, which is bent to form a locking bar 51, two extension arms 53 perpendicularly extend from opposite ends of the locking bar 51, and two pivot shafts 55 respectively perpendicularly extend toward each other from the ends of the corresponding extension arms 53 away from the locking bar 51.

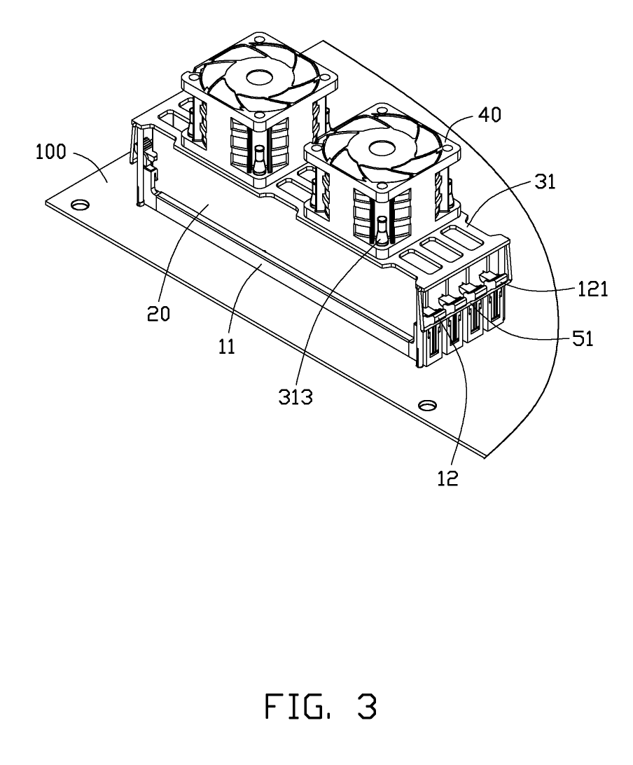

Referring to FIG. 3, in assembly, the fans 40 are disposed on the mounting plate 31 and correspondingly align with the through holes 311, with the fasteners 313 engaging in the corresponding mounting holes 44 of the fans 40. The handles 50 are respectively rotatably attached to the opposite ends of the mounting plate 31, with the pivot shafts 53 of each of the handles 50 correspondingly rotatably received in two pivot holes 315 at one of the opposite ends of the mounting plate 31.

In mounting of the heat dissipation apparatus to the circuit board 100, the mounting bracket 30 is manipulated to engage the legs 32 into the corresponding locating holes 102 of the circuit board 100, thereby positioning the mounting plate 31 over the memory cards 20. The catch 3212 of each of the legs 32 engages with a bottom side of the circuit board 100. The block 3222 of each of the legs 32 abuts against a top side of the circuit board 100 to prevent the mounting bracket 30 from falling down. The handles 50 are pivoted down, until the locking bars 51 correspondingly engage with a bottom side of the grips 121 at opposite ends of the memory cards 20, thereby retaining the heat dissipation apparatus to the circuit board 100. Since the handles 50 tend to pivot the retaining portions 12 toward the corresponding memory cards 20, mounting of the heat dissipation apparatus will tighten the retaining portions 12 against the memory cards 20, rather than releasing the retaining portions 12 from the memory cards 20.

In use, the fans 40 produce airflow, which flows through the through holes 311 to the memory cards 20 to effectively accelerate heat dissipation of the memory cards 20.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A heat dissipation apparatus for a memory card coupled to a memory connector of a circuit board, the heat dissipation apparatus comprising:
a mounting bracket comprising a mounting plate to be arranged over the memory card, and a plurality of legs extending down from the mounting plate to be supported on the circuit board; and
a fan fixed to the mounting plate to align with the memory card.

2. The heat dissipation apparatus of claim 1, wherein the mounting plate defines a through hole, the fan is attached to a top side of the mounting plate and aligned with the through hole.

3. The heat dissipation apparatus of claim 1, further comprising two handles rotatably mounted to opposite ends of the mounting plate and to be detachably retained to the memory connector.

4. The heat dissipation apparatus of claim 1, wherein each of the legs are operable to extend through the circuit board, and comprises a catch for engaging with a bottom side of the circuit board, and a block for abutting against a top side of the circuit board.

5. The heat dissipation apparatus of claim 4, wherein each of the legs defines an axial split in a distal end of the leg to form a first retaining portion, and a second retaining portion at opposite sides of the split, the catch protrudes from the first retaining portion opposite to the second retaining portion, the block protrudes from the second retaining portion opposite to the first retaining portion.

6. An electronic device comprising:
a circuit board defining a plurality of locating holes;
a memory connector disposed on a top side of the circuit board, and in an area bounded by the locating holes;
a memory card connected to the memory connector;
a mounting bracket comprising a mounting plate arranged over the memory card, and a plurality of legs extending down from the mounting plate and correspondingly engaged in the locating holes of the circuit board; and
a fan fixed to the mounting plate and aligning with the memory card.

7. The electronic device of claim 6, wherein each of the legs forms a catch engaging with a bottom side of the circuit board, and a block abutting against the top side of the circuit board.

8. The electronic device of claim 7, wherein each of the legs defines an axial split in a distal end of the leg to form a first retaining portion, and a second retaining portion at opposite sides of the split, the catch protrudes from the first retaining portion opposite to the second retaining portion, the block protrudes from the second retaining portion opposite to the first retaining portion.

9. The electronic device of claim 6, further comprising two handles rotatably mounted to opposite ends of the mounting plate, wherein the memory connector comprises a coupling slot receiving the memory card, and two retaining portions rotatably mounted to opposite ends of the coupling slot to be retained to opposite ends of the corresponding memory card, the handles are detachably engaged with the retaining portions.

10. The electronic device of claim 9, wherein each of the retaining portions comprises a grip protrudes away from the memory card, each of the handles comprises a locking bar to abutting against a bottom of the grip of a corresponding retaining portion.

11. The electronic device of claim 10, wherein each of handles further comprises two extension arms perpendicularly extending from opposite ends of the locking bar, and two pivot shafts perpendicularly extending towards each other from ends of the corresponding extension arms away from the locking bar, each of opposite lateral side surfaces of the mounting plate defines two pivot holes, respectively adjacent to the opposite ends of the mounting plate, the pivot shafts of each of the handles are rotatably received in two corresponding pivot holes adjacent to one of opposite ends of the mounting plate.
